(19) United States
(12) Patent Application Publication
(10) Pub. No.: US 2006/0036757 A1
(43) Pub. Date: Feb. 16, 2006

(54) Multimedia content display system having scheduling function and method of reproducing content using the system

(75) Inventors: Kwang-yun Na, Suwon-si (KR); Eun-hee Rhim, Suwon-si (KR); Ui-chol Roh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD

(21) Appl. No.: 11/186,983

(22) Filed: Jul. 22, 2005

(30) Foreign Application Priority Data
Aug. 13, 2004 (KR) 10-2004-0063960

(51) Int. Cl. G06F 15/16

(52) U.S. Cl. 709/231

(57) ABSTRACT

A multimedia content display system is provided having a scheduling function, as well as a method of reproducing content using the system. The system includes a server which transmits designated content to a corresponding client at a designated time based on schedule information of the corresponding client, and one or more clients which receive the designated content from the server and reproduce the content. Accordingly, content can be designated for a particular month, day, and time such that designated content can be reproduced at a designated time and, thus, a server can efficiently manage a plurality of display devices.

### BACKGROUND OF THE INVENTION

This application claims priority from Korean Patent Application No. 10-2004-0063960, filed on Aug. 13, 2004, in the Korean Intellectual Property Office, the disclosure of which is incorporated herein by reference.

1. Field of the Invention

The present invention relates to a display system, and more particularly, to a multimedia content display system having a scheduling function and a method for reproducing content using the system.

2. Description of the Related Art

With the development of display devices, it is no longer unusual to see large display devices which display multimedia content such as news, movies, advertisements, announcements, and informative text messages, in locations such as airports, department stores, government and public offices, and schools.

FIG. 1 is a configuration diagram of a conventional multimedia content display system. Referring to FIG. 1, the conventional multimedia content display system includes a plurality of display devices 102 respectively connected to a plurality of servers 104 providing multimedia content to be reproduced. The display devices 102 receive multimedia content from the servers 104, and reproduce the received multimedia content. Hereinafter, the display devices 102 will be called “clients,” to denote that they correspond to the servers 104. Thus, the clients 102 display a list of content provided by the servers 104, and request content, which is selected by a user, from the servers 104. The servers 104 then transmit the requested content to the clients 102, which in turn receive and reproduce the requested content.

According to the configuration shown in FIG. 1, a conventional multimedia content display system has a plurality of content servers 104 corresponding to a plurality of display devices 102. However, since the servers 104 are not connected to one another, it is difficult to make one of the servers 104 control the display devices 102 to reproduce various content and manage the servers 104.

FIG. 2 is a block diagram of the conventional multimedia content display system of FIG. 1. In FIG. 2, one of the servers 104 and one of the clients 102 are illustrated, as representatives of the other servers 104 and clients 102. Referring to FIG. 2, the client 102 displays a list of content provided by the server 104 on a content list viewer 206, such that a user can view the list of content. When the user selects desired content, the client 102 requests the selected content from the server 104. Then, a content list provider 206 of the server 104 retrieves the requested content from its content database 216 and the retrieved content is transmitted, i.e., streamed, to the client 102 through a content provider 214. The client 102 receives the streamed content through a content receiver 208, reproduces the content using an audio/video (AV) decoder 210, and displays the content on a display screen.

According to this conventional system, the server 104 can transmit multimedia content to the client 102 only when the user selects the multimedia content at the client 102. Hence, there is a limitation on the ability of servers 104 to control each of the clients 102 to reproduce various content.

### SUMMARY OF THE INVENTION

An aspect of the present invention provides a multimedia content display system having a scheduling function and a method of reproducing content using the system. Another aspect of the present invention provides a multimedia content display system that can be controlled by a user to automatically reproduce desired content at a desired time.

According to an aspect of the present invention, there is provided a multimedia content display system including a server, which transmits designated content to a corresponding client at a designated time based on schedule information of a corresponding client; and one or more clients, which receive the content from the server and reproduce the content.

The server may include a schedule organizer which registers or edits the schedule information of each of the clients using a schedule database.

The server may include a scheduler which controls the server so as to transmit the content to a corresponding client at a designated time based on schedule information created by the schedule organizer.

The clients may reproduce the content based on the schedule information, and each client may further include a user interface by which a user can directly select desired content to be reproduced.

According to another aspect of the present invention, there is provided a server connected to a plurality of clients which reproduce multimedia content, wherein the server designates the content to be reproduced and the time to reproduce the content differently for each of the clients as schedule information, and transmits designated content to a corresponding client at the designated time based on the schedule information of each of the clients.

According to another aspect of the present invention, there is provided a plurality of clients connected to a server, which stores schedule information regarding the content to be reproduced and the time to reproduce the content, for each of the clients, wherein the clients receive designated content from the server at the designated time and reproduce the designated content.

According to another aspect of the present invention, there is provided a method of reproducing multimedia content. The method includes reading schedule information of each of one or more clients which reproduce multimedia content, wherein the schedule information indicates the content to be reproduced and the time to reproduce the content; reading designated content at a designated time based on the read schedule information; and transmitting the read designated content to the corresponding client at the designated time and reproducing the transmitted content.

### BRIEF DESCRIPTION OF THE DRAWINGS

The above and other aspects of the present invention will be readily apparent by describing in detail exemplary embodiments of the present invention with reference to the attached drawings, in which:

FIG. 1 is a configuration diagram of a conventional multimedia content display system;

FIG. 2 is a block diagram representative of the conventional multimedia content display system of FIG. 1;

FIG. 3 is a configuration diagram of a multimedia content display system according to an exemplary embodiment of the present invention;

FIG. 4 is a block diagram representative of the multimedia content display system of FIG. 3;

FIG. 5 illustrates a multimedia content display system according to an exemplary embodiment of the present invention;

FIG. 6 illustrates a user interface (hereinafter “UI”) included in a server of a multimedia content display system according to an exemplary embodiment of the present invention;

FIG. 7 is a reference diagram illustrating a scheduling function provided by a server included in a multimedia content display system according to an exemplary embodiment of the present invention;

FIG. 8 illustrates a UI needed for a scheduling function provided by a server included in a multimedia content display system according to an exemplary embodiment of the present invention;

FIG. 9 illustrates a client of a multimedia content display system, which is implemented as hardware according to an exemplary embodiment of the present invention;

FIG. 10 illustrates a UI provided by each client, which is used to select content according to an exemplary embodiment of the present invention;

FIG. 11 is a reference diagram illustrating a method of reproducing content using schedule information, which is designated differently for each of the clients included in a multimedia content display system, according to an exemplary embodiment of the present invention; and

FIG. 12 is a flowchart illustrating a method of reproducing multimedia content using content information and schedule information, which is designated differently for each of the clients included in a multimedia content display system, according to an exemplary embodiment of the present invention.

### DETAILED DESCRIPTION OF THE EXEMPLARY EMBODIMENTS OF THE INVENTION

The various aspects of the present invention will now be described more fully by describing certain exemplary embodiments thereof with reference to the accompanying drawings. However, the present invention may be embodied in many different forms and should not be construed as being limited to the exemplary embodiments set forth herein, rather, these exemplary embodiments are provided merely as examples to assist in conveying an understanding of the invention to those skilled in the art.

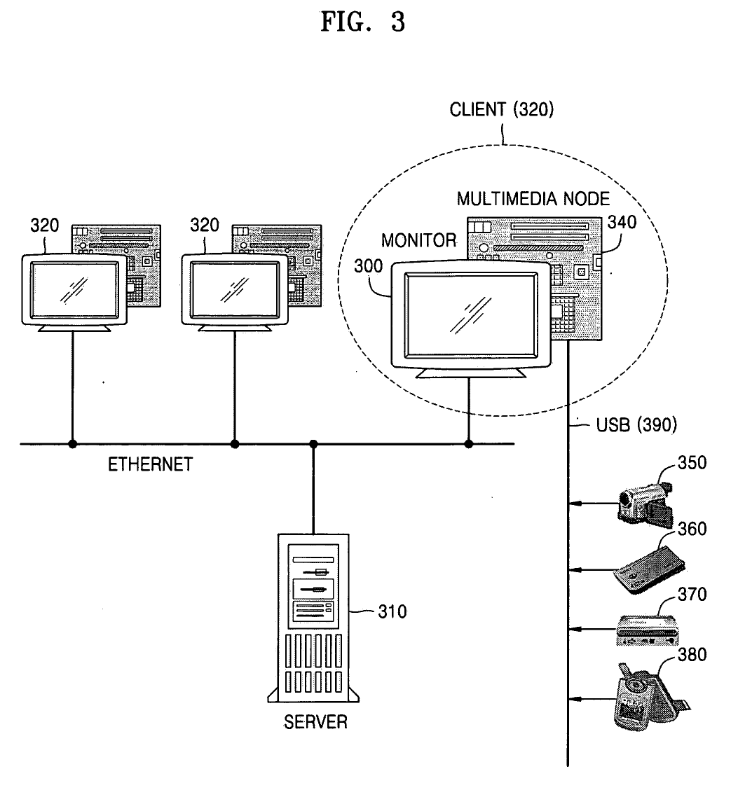

FIG. 3 is a configuration diagram of a multimedia content display system according to an exemplary embodiment of the present invention. Referring to FIG. 3, the multimedia content display system includes a server 310 and a plurality of display devices, i.e., a plurality of clients 320, connected to one another through a network (e.g., an Ethernet network). Each of the clients 320 includes a monitor 330 for displaying content and a moving-image node (or a multimedia node) 340 for decoding and reproducing content received from the server 310. Alternatively, various multimedia devices, such as a camcorder 350, a DVD recorder/player 370, a memory card 360, and a mobile phone 380, may be connected to the multimedia content display system through a universal serial bus (“USB”) 390.

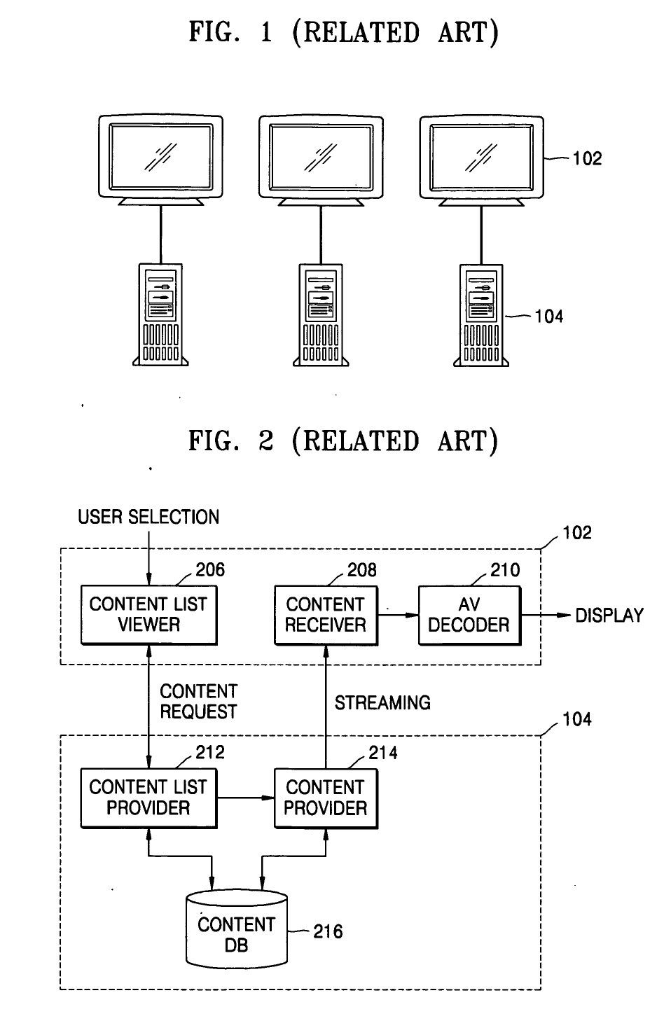

Unlike the conventional multimedia content display system of FIG. 1, a multimedia content display system, according to the exemplary embodiment of the present invention, can easily manage and control the clients 320. In addition, the server 310 provides a scheduling function, which will be described below, and can control each of the clients 320, respectively, to automatically reproduce multimedia content that is designated for a particular client at a designated time.

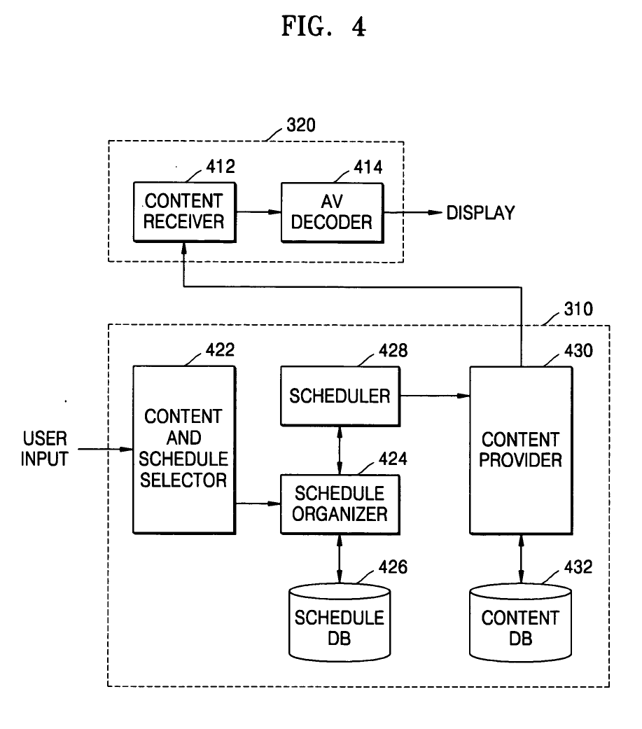

FIG. 4 is a block diagram representative of the exemplary multimedia content display system shown in FIG. 3. Referring to FIG. 4, according to an exemplary embodiment of the present invention, the multimedia content display system includes the server 310 and the clients 320. Further, in the exemplary multimedia content display system, a server may be connected to a plurality of clients through a network. Alternatively, a plurality of servers may be connected to a plurality of clients similar to the conventional multimedia content display system. However, it may be advantageous to provide an integrated server and to connect a plurality of clients to one another through a network to easily manage and control the clients. The server 310 provides a scheduling function and controls each of the clients 320 to automatically reproduce content at a time designated by a user.

Specifically, the server 310 includes a content and schedule selector 422, a schedule organizer 424, a schedule database 426, a scheduler 428, a content provider 430, and a content database 432.

The content and schedule selector 422 receives content and schedule information, regarding the time to reproduce the content, from a user. Based on the information received by the content and schedule selector 422, the schedule organizer 424 stores content to be reproduced by a corresponding client and schedule information regarding the time to reproduce the content, in the schedule database 426. The schedule organizer 424 can create new schedule information, or modify or delete existing schedule information of each of the clients 320.

The schedule database 426 stores schedule information created, modified, or deleted by the schedule organizer 424. The scheduler 428 controls each of the clients 320, so as to reproduce content that has been designated for a respective client at a designated time, based on information stored in the schedule database 426. Controlled by the scheduler 428, the content provider 430 transmits designated content to a corresponding client at a designated time. A representative transmission method may be, for example, a streaming service. The content database 432 stores multimedia content that is provided to the clients 320. Various forms of multimedia content data are stored in the content database 432, such as moving-image information including movies, advertisements and news, informative text messages, announcements, and still images.

Each of the clients 320 includes a content receiver 412 and an audio/video (“AV”) decoder 414. Each of the clients 320 may further include a controller and a monitor, although these features are not shown in the drawing. The content receiver 412 receives multimedia content transmitted through the network from the content provider 430 included in the server 310. The received multimedia content is decoded by the AV decoder 414 and is then displayed on a display screen.

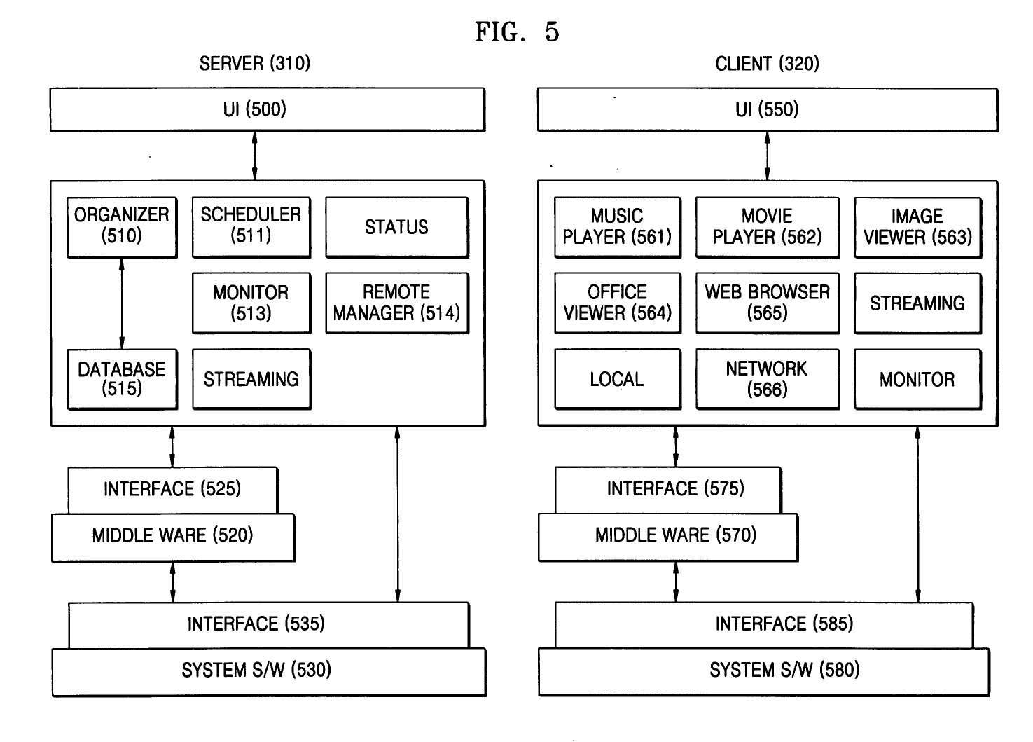

FIG. 5 illustrates a multimedia content display system according to an exemplary embodiment of the present invention. Referring to FIG. 5, the exemplary multimedia content display system depicted has the same general architecture as the multimedia content display system of FIG. 4. A server 310 receives information regarding content and schedules, through a user interface (“UI”) 500. Based on the received information, an organizer 510 manages a database 515 and, for example, can create new schedule information, or modify or delete existing schedule information of each of the clients 320, respectively. A scheduler 511 starts to stream multimedia content to a corresponding client 320 at a designated time based on the schedule information in the database 515. The multimedia content is transmitted to the client 320 through a network via middleware 520 and system software 530, using their respective interfaces 525 and 535.

A network 566 included in the client 320 receives the multimedia content via system software 580 and middleware 570, using their respective interfaces 585 and 575. The received multimedia content is reproduced by diverse media reproducers such as a music player 561, a movie player 562, an image viewer 563, an office viewer 564, and a web browser 565.

The server 310 can control the client 320 to automatically reproduce designated content at a designated time using the scheduler 511. In addition, the client 320 can receive multimedia content directly from a user using the UI 550 and can reproduce the multimedia content. Also, the server 310 can monitor the status of a plurality of clients using a monitor 513 and can remotely control the status of the clients using a remote manager 514.

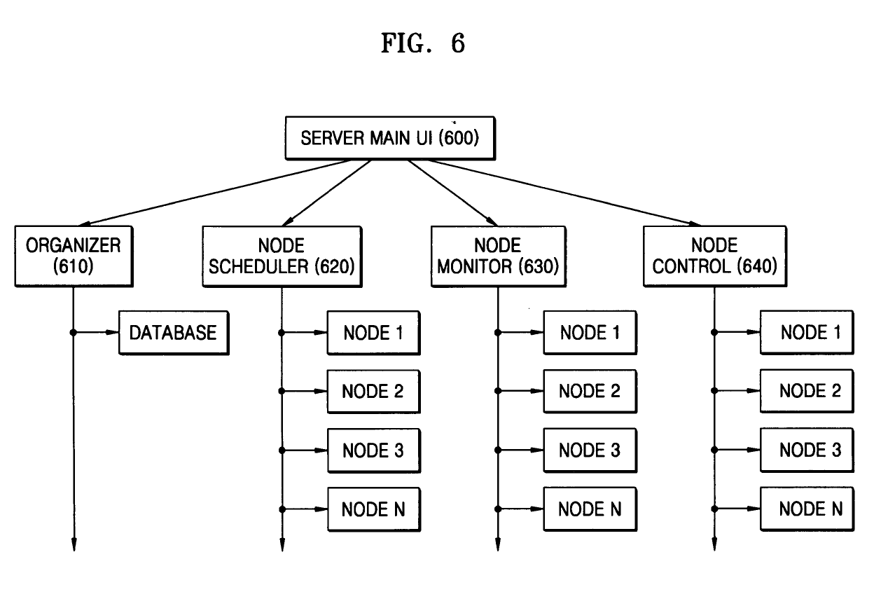

FIG. 6 illustrates a server main UI 600 included in the server 310 of a multimedia content display system according to an exemplary embodiment of the present invention. As described above, the server 310 can manage schedules of the clients 320, monitor the status of the clients 320, and control the clients 320, using the server main UI 600. Referring to FIG. 6, the server 310 can manage, i.e., create, modify, and delete, the schedule database and the content database using an organizer 610. In addition, the server 310 controls a node scheduler 620 to transmit designated multimedia content to a corresponding client at a time designated for the client. The server 310 can also monitor the status of the clients 320 using a node monitor 630 and can remotely control the status of the clients 320 using a node control 640.

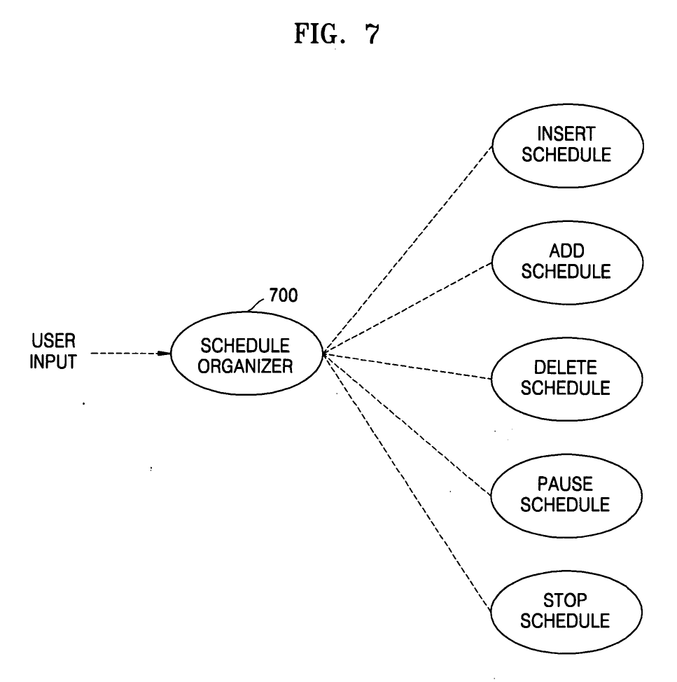

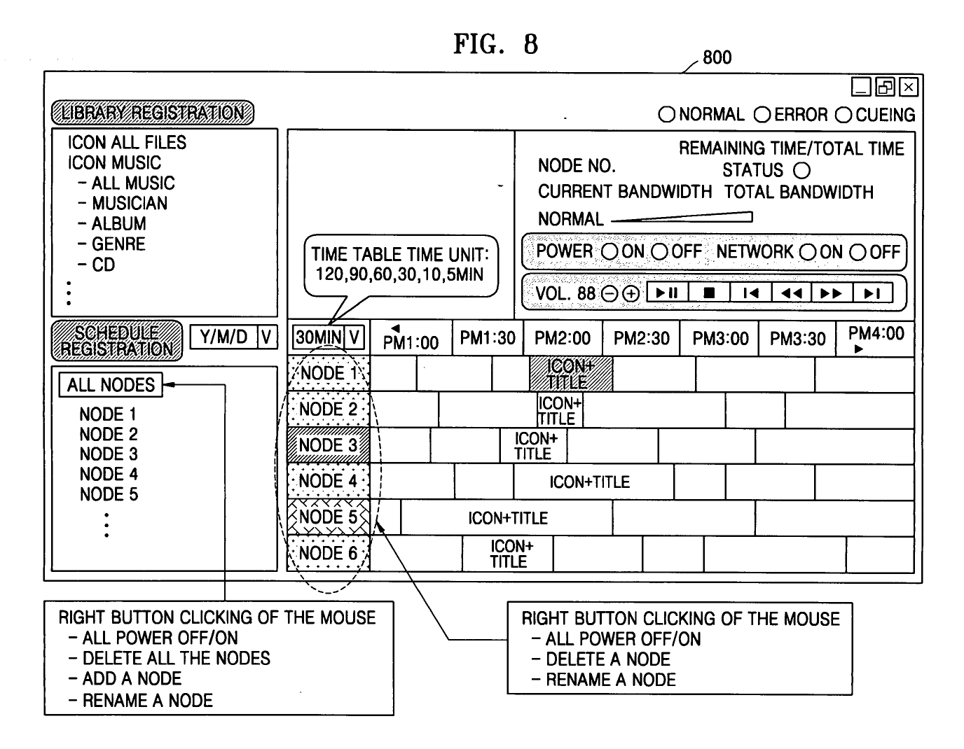

FIG. 7 is a reference diagram illustrating a scheduling function provided by the server 310 included in a multimedia content display system according to an exemplary embodiment of the present invention. Referring to FIG. 7, the schedule organizer 700 receives an input from a user and inserts, adds, deletes, pauses, or stops a schedule for each client. Schedule information is stored in a schedule database and referred to by the scheduler, as described above, such that designated content can be transmitted to a corresponding client at a designated time.

FIG. 8 illustrates an UI 800 which can be used for the scheduling function provided by the server 310 included in a multimedia content display system according to an exemplary embodiment of the present invention. FIG. 8 illustrates a screen by which schedule information for each client (node) 320 can be registered. In particular, multimedia content to be reproduced at a certain time can be designated for each of the clients 320, respectively, using the UI 800. In addition, schedule information for each of the clients 320 can be added, modified, or deleted using the UI 800, and the clients 320, i.e., nodes, can be added, modified, or deleted using the UI 800. Further, the current reproduction status of each of the clients 320 can be monitored through the UI 800.

Accordingly, content can be designated for each month, day, and time such that designated content can be reproduced at a designated time. Thus, the UI 800 can be used to efficiently transmit and reproduce different or identical content to each of the clients 320, respectively.

For example, a multimedia content display system according to an exemplary embodiment of the present invention, which is placed at, for example, an airport, a department store, or a public or government office may store schedule information as follows:

From 10:00 to 12:00:
Client 1: Repeatedly reproduces music (e.g., xx.mp3)
Client 2: Reproduces video (e.g., xx.mpeg)

From 12:00 to 13:00:
All clients: Display still-images (e.g., xxjpg)

In this exemplary embodiment, a server automatically transmits designated content to a corresponding client at the time set in the schedule information. The transmitted content is then automatically reproduced by the client.

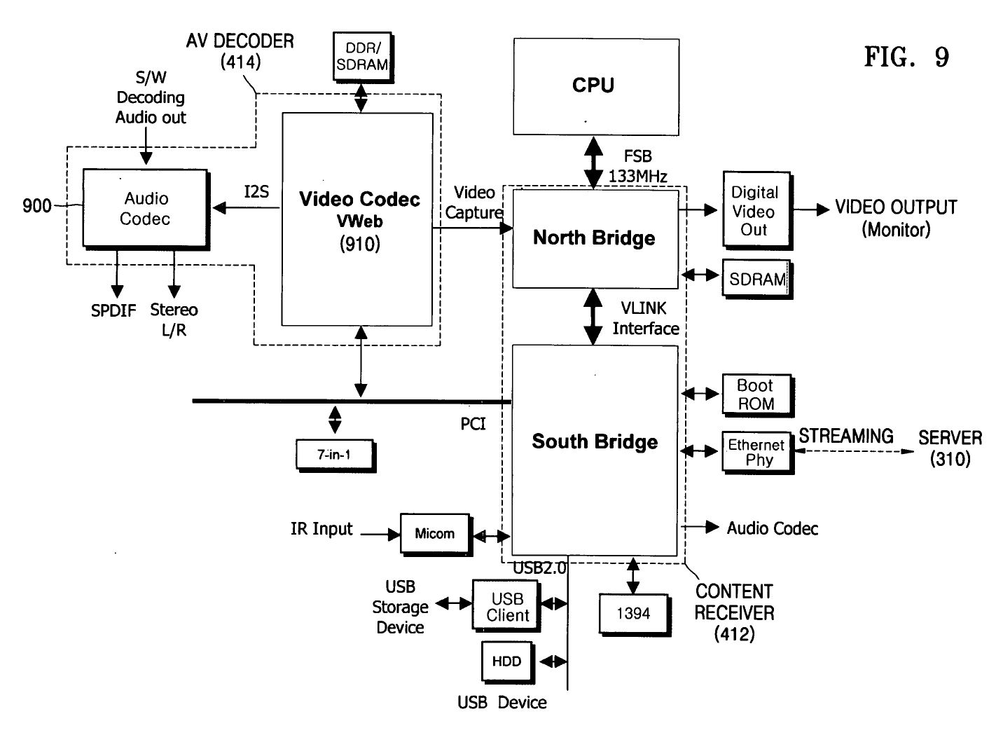

FIG. 9 illustrates a client of a multimedia content display system, which is implemented as hardware, according to an exemplary embodiment of the present invention. Referring to FIG. 9, multimedia content received from the server 310 through a network is transmitted to the AV decoder 414, which includes video encoders and decoders 910 (hereinafter, called “codecs”) and audio codecs 900 via the content receiver 412. The AV decoder 414 decodes the multimedia content and outputs the corresponding decoded multimedia content.

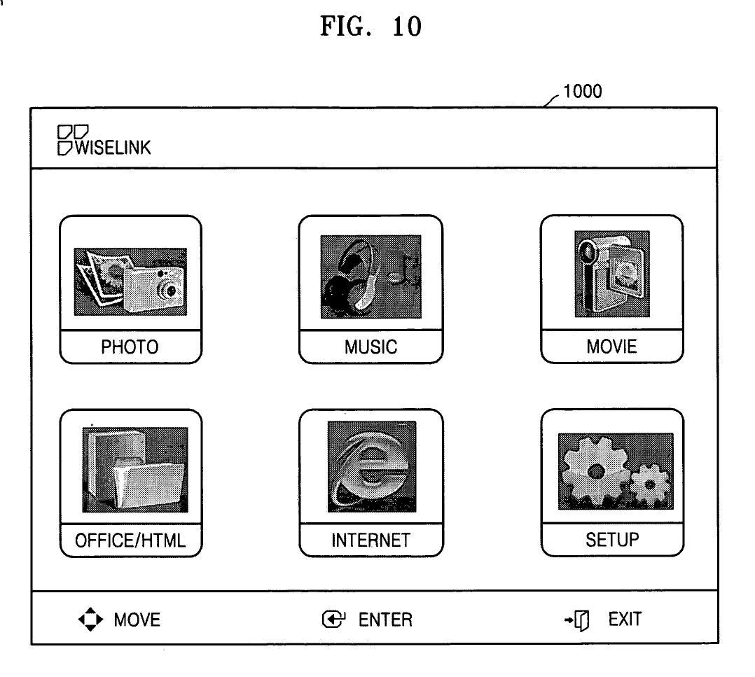

FIG. 10 illustrates an UI 1000 provided by each of the clients 320, used to select content according to an exemplary embodiment of the present invention. Referring to FIG. 10, designated multimedia content can be automatically transmitted to a corresponding client and can be reproduced at a designated time according to schedule information. In addition, the client can receive an input directly from a user and can thereby reproduce multimedia content. For example, a list of multimedia content that can be provided by the server 310 is displayed on a menu screen provided by each of the clients 320. Accordingly, when a user selects desired multimedia content from the list of multimedia content displayed on the menu screen, a corresponding client reproduces the selected multimedia content.

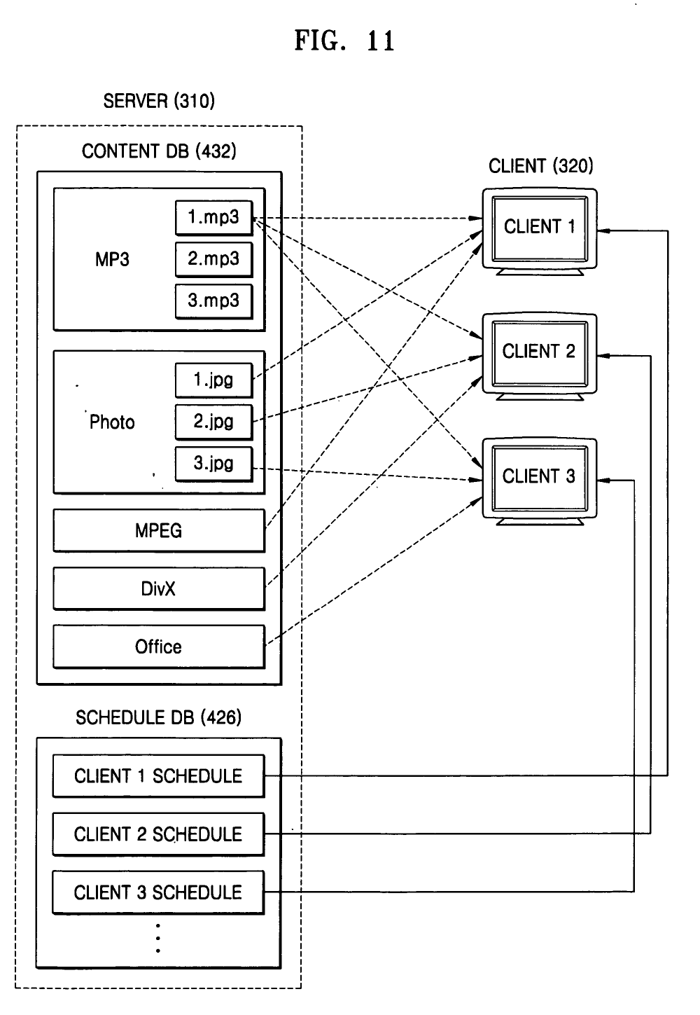

FIG. 11 is a reference diagram illustrating a method of reproducing content using schedule information which is designated differently for each of the clients 320, respectively, included in a multimedia content display system according to an exemplary embodiment of the present invention. Referring to FIG. 11, multimedia content designated according to schedule information of each of the clients 320, which is stored in the schedule database 426, is provided to the clients 320, respectively, at designated times. Thus, the content and the time to reproduce the content may be designated differently for each of the respective clients 320.

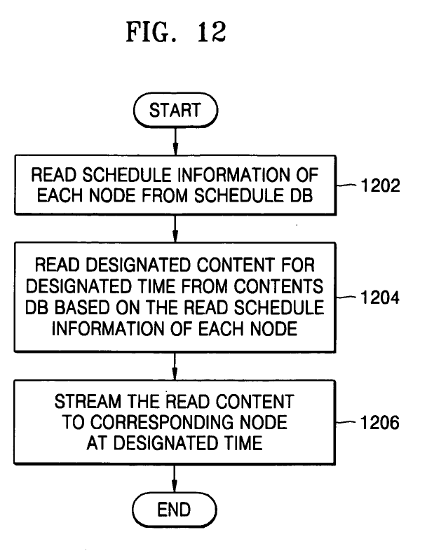

FIG. 12 is a flowchart illustrating a method of reproducing multimedia content using content information and schedule information, which are designated differently for each of the clients 320, respectively, included in a multimedia content display system according to an exemplary embodiment of the present invention. Referring to FIG. 12, the server 310 reads schedule information of the clients (nodes) 320 from the schedule database 426 (operation 1202). Based on the read schedule information of the clients 320, the server 310 reads designated content, for a designated time, from the content database 432 (operation 1204). Then, the server 310 transmits the read content to a corresponding client 320 at the designated time (operation 1206). The transmitted content is then reproduced and displayed by the corresponding client 320.

As described above, exemplary embodiments of the present invention provide a multimedia content display system having a scheduling function and a method of reproducing content using the system. A server included in a multimedia content display system according to exemplary embodiments of the present invention can easily manage a plurality of display devices (clients).

In addition, using its scheduling function, a multimedia content display system consistent with the present invention can control one or more clients, respectively, to automatically reproduce designated multimedia content at a time designated for that the respective client. In other words, content can be designated for a particular month, day, and time such that designated content can be reproduced at a designated time.

Aspects of the present invention can also be implemented as computer-readable code on a computer-readable recording medium. The computer-readable recording medium can be any data storage device that can store data which can be thereafter read by a computer system. Examples of such computer-readable recording mediums include, but are not limited to, read-only memory (ROM), random-access memory (RAM), CD-ROMs, magnetic tapes, floppy disks, optical data storage devices, and carrier waves (such as data transmission through the internet).

Consistent with the present invention, the computer-readable recording medium can also be distributed over network-coupled computer systems so that the computer-readable code is stored and executed in a distributed fashion.

While the present invention has been particularly shown and described with reference to exemplary embodiments thereof, the foregoing exemplary embodiments are merely illustrative and are not to be construed as limiting the present invention. Indeed, it will be understood by those of ordinary skill in the art that various changes in form and details may be made to the exemplary embodiments without departing from the spirit and scope of the present invention as defined by the following claims.

What is claimed is:

1. A multimedia content display system comprising:
at least one client; and
a server which transmits designated content to the client at a designated time based on schedule information of the client,
wherein the client receives the designated content from the server and reproduces the designated content.

2. The multimedia content display system of claim 1, wherein the server comprises a schedule organizer which registers or edits the schedule information of the client using a schedule database.

3. The multimedia content display system of claim 2, wherein the server comprises a scheduler which controls the server to transmit the designated content to the client at the designated time based on the schedule information created, registered, or edited by the schedule organizer.

4. The multimedia content display system of claim 1, wherein the at least one client comprises a user interface by which a user can directly select the designated content to be reproduced, wherein the client reproduces the designated content based on the schedule information, and further comprises a user interface by which a user can directly select desired content to be reproduced.

5. A server connected to a plurality of clients which reproduce multimedia content, the server comprising:
a content and schedule selector which designates content to be reproduced and designates a time to reproduce the designated content differently for each of the plurality of clients, as schedule information;
a content provider which transmits the designated content to at least one client among the plurality of clients at a designated time based on the schedule information of each of the plurality of clients.

6. A plurality of clients connected to a server which stores schedule information regarding designated content to be reproduced and a designated time to reproduce the content for each of the clients, each of the clients comprising:
a content receiver which receives designated content from the server at the designated time; and
an audio/video (AV) decoder which reproduces the designated content.

7. A method of reproducing multimedia content, the method comprising:
reading schedule information of at least one client which reproduces multimedia content, wherein the schedule information indicates designated content to be reproduced and a designated time to reproduce the content;
reading the designated content at the designated time based on the read schedule information; and
transmitting the designated content which is read to the client at the designated time and reproducing the transmitted content.

8. The multimedia content display system according to claim 1, wherein the server designates content to be reproduced and designates a time to reproduce the designated content independently for each of a plurality of clients.

9. The server of claim 5, further comprising:
a schedule database which stores the designated content and the schedule information; and
a scheduler which controls each of the clients so as to reproduce the designated content at the designated time based on information stored in the schedule database.

10. The server according to claim 9 further comprising a content database which stores multimedia content that is provided to the at least one client.

11. The server according to claim 9 wherein the scheduler controls each of the clients independently to reproduce the designated content at the designated time or times based on information stored in the schedule database

12. The server according to claim 9 further comprising a node monitor which monitors the status of the clients.

13. The server according to claim 9 further comprising a node control which remotely controls the status of the clients.
